(19) United States
(12) Patent Application Publication
(10) Pub. No.: US 2024/0129681 A1
(43) Pub. Date: Apr. 18, 2024

(54) SCALING AUDIO SOURCES IN EXTENDED REALITY SYSTEMS

(71) Applicant: QUALCOMM Incorporated, San Diego, CA (US)

(72) Inventors: Isaac Garcia Munoz, San Diego, CA (US); Alex Tung, San Diego, CA (US); Graham Bradley Davis, Seattle, WA (US); Andre Schevciw, San Diego, CA (US)

(21) Appl. No.: 18/045,839

(22) Filed: Oct. 12, 2022

(51) Int. Cl. H04S 7/00; G10L 19/008

(52) U.S. Cl. CPC H04S 7/30; G10L 19/008; H04S 2420/11

(57) ABSTRACT

In general, various aspects of the techniques are directed to rescaling audio element for extended reality scene playback. A device comprising a memory and processing circuitry may be configured to perform the techniques. The memory may store an audio bitstream representative of an audio element in an extended reality scene. The processing circuitry may obtain a playback dimension associated with a physical space in which playback of the audio bitstream is to occur, and obtain a source dimension associated with a source space for the extended reality scene. The processing circuitry may modify, based on the playback dimension and the source dimension, a location of the audio element to obtain a modified location for the audio element, and render, based on the modified location for the audio element, the audio element to one or more speaker feeds. The processing circuitry may output the one or more speaker feeds.

### TECHNICAL FIELD

This disclosure relates to processing of audio data.

### BACKGROUND

Computer-mediated reality systems are being developed to allow computing devices to augment or add to, remove or subtract from, or generally modify existing reality experienced by a user. Computer-mediated reality systems (which may also be referred to as “extended reality systems,” or “XR systems”) may include, as examples, virtual reality (VR) systems, augmented reality (AR) systems, and mixed reality (MR) systems. The perceived success of computer-mediated reality systems are generally related to the ability of such computer-mediated reality systems to provide a realistically immersive experience in terms of both the visual and audio experience where the visual and audio experience align in ways expected by the user. Although the human visual system is more sensitive than the human auditory systems (e.g., in terms of perceived localization of various objects within the scene), ensuring an adequate auditory experience is an increasingly import factor in ensuring a realistically immersive experience, particularly as the visual experience improves to permit better localization of visual objects that enable the user to better identify sources of audio content.

### SUMMARY

This disclosure generally relates to techniques for scaling audio sources in extended reality systems. Rather than require users to only operate extended reality systems in locations that permit one-to-one correspondence in terms of spacing with a source location at which the extended reality scene was captured and/or for which the extended reality scene was generated, various aspects of the techniques enable an extended reality system to scale a source location to accommodate a playback location. As such, if the source location includes microphones that are spaced 10 meters (10 M) apart, the extended reality system may scale that spacing resolution of 10 M to accommodate a scale of a playback location using a scaling factor that is determined based on a source dimension defining a size of the source location and a playback dimension defining a size of a playback location.

Using the scaling provided in accordance with various aspects of the techniques described in this disclosure, the extended reality system may improve reproduction of the soundfield to modify a location of audio sources to accommodate the size of the playback space. In enabling such scaling, the extended reality system may improve an immersive experience for the user when consuming the extended reality scene given that the extended reality scene more closely matches the playback space. The user may then experience the entirety of the extended reality scene safely within the confines of the permitted playback space. In this respect, the techniques may improve operation of the extended reality system itself.

In one example, the techniques are directed to a device configured to process an audio bitstream, the device comprising: a memory configured to store the audio bitstream representative of an audio element in an extended reality scene; and processing circuitry coupled of the memory and configured to: obtain a playback dimension associated with a physical space in which playback of the audio bitstream is to occur; obtain a source dimension associated with a source space for the extended reality scene; modify, based on the playback dimension and the source dimension, a location of the audio element to obtain a modified location for the audio element; render, based on the modified location for the audio element, the audio element to one or more speaker feeds; and output the one or more speaker feeds.

In another example, the techniques are directed to a method of processing an audio element, the method comprising: obtaining a playback dimension associated with a physical space in which playback of an audio bitstream is to occur, the audio bitstream representative of the audio element in an extended reality scene; obtaining a source dimension associated with a source space for the extended reality scene; modifying, based on the playback dimension and the source dimension, a location of the audio element to obtain a modified location for the audio element; rendering, based on the modified location for the audio element, the audio element to one or more speaker feeds; and outputting the one or more speaker feeds.

In another example, the techniques are directed to a device configured to encode an audio bitstream, the device comprising: a memory configured to store an audio element, and processing circuitry coupled to the memory, and configured to: specify, in the audio bitstream, a syntax element indicative of a rescaling factor for the audio element, the rescaling factor indicating how a location of the audio element is to be rescaled relative to other audio elements; and output the audio bitstream.

In another example, the techniques are directed to a method for encoding an audio bitstream, the method comprising: specifying, in the audio bitstream, a syntax element indicative of a rescaling factor for an audio element, the rescaling factor indicating how a location of the audio element is to be rescaled relative to other audio elements; and output the audio bitstream.

The details of one or more examples of this disclosure are set forth in the accompanying drawings and the description below. Other features, objects, and advantages of various aspects of the techniques will be apparent from the description and drawings, and from the claims.

### BRIEF DESCRIPTION OF DRAWINGS

FIGS. 1A and 1B are diagrams illustrating systems that may perform various aspects of the techniques described in this disclosure.

FIG. 2 is a block diagram illustrating example physical spaces in which various aspects of the rescaling techniques are performed in order to facilitate increased immersion while consuming extended reality scenes.

FIGS. 3A and 3B are block diagrams illustrating further example physical spaces in which various aspects of the rescaling techniques are performed in order to facilitate increased immersion while consuming extended reality scenes.

FIGS. 4A and 4B are flowcharts illustrating exemplary operation of an extended reality system shown in the example of FIG. 1 in performing various aspects of the rescaling techniques described in this disclosure.

FIGS. 5A and 5B are diagrams illustrating examples of XR devices.

FIG. 6 illustrates an example of a wireless communications system that supports audio streaming in accordance with aspects of the present disclosure.

### DETAILED DESCRIPTION

There are a number of different ways to represent a soundfield. Example formats include channel-based audio formats, object-based audio formats, and scene-based audio formats. Channel-based audio formats refer to the 5.1 surround sound format, 7.1 surround sound formats, 22.2 surround sound formats, or any other channel-based format that localizes audio channels to particular locations around the listener in order to recreate a soundfield.

Object-based audio formats may refer to formats in which audio objects, often encoded using pulse-code modulation (PCM) and referred to as PCM audio objects, are specified in order to represent the soundfield. Such audio objects may include metadata identifying a location of the audio object relative to a listener or other point of reference in the soundfield, such that the audio object may be rendered to one or more speaker channels for playback in an effort to recreate the soundfield. The techniques described in this disclosure may apply to any of the foregoing formats, including scene-based audio formats, channel-based audio formats, object-based audio formats, or any combination thereof.

Scene-based audio formats may include a hierarchical set of elements that define the soundfield in three dimensions. One example of a hierarchical set of elements is a set of spherical harmonic coefficients (SHC). The following expression demonstrates a description or representation of a soundfield using SHC:

$${p}_{i} ( t , {r}_{r} , {θ}_{r} , {φ}_{r} ) = {\sum }_{ω = 0}^{∞} [ 4 π {\sum }_{n = 0}^{∞} {j}_{n} ( {kr}_{r} ) {\sum }_{m = - n}^{n} {A}_{n}^{m} ( k ) {Y}_{n}^{m} ( {θ}_{r} , {φ}_{r} ) ] {e}^{j ω t} ,$$

The expression shows that the pressure pᵢ at any point {rᵣ, θᵣ, φᵣ} of the soundfield, at time t, can be represented uniquely by the SHC, Aₙ^{m}(k). Here,

$$k = \frac{ω}{c} ,$$

is the speed of sound (˜343 m/s), {rᵣ,θᵣ, φᵣ} is a point of reference (or observation point), jₙ(⋅) is the spherical Bessel function of order n, and Yₙ^{m}(θᵣ, φᵣ) are the spherical harmonic basis functions (which may also be referred to as a spherical basis function) of order n and suborder m. It can be recognized that the term in square brackets is a frequency-domain representation of the signal (i.e., S(ω, rᵣ, θᵣ, φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

The SHC Aₙ^{m}(k) can either be physically acquired (e.g., recorded) by various microphone array configurations or, alternatively, they can be derived from channel-based or object-based descriptions of the soundfield. The SHC (which also may be referred to as ambisonic coefficients) represent scene-based audio, where the SHC may be input to an audio encoder to obtain encoded SHC that may promote more efficient transmission or storage. For example, a fourth-order representation involving (1+4)² (25, and hence fourth order) coefficients may be used.

As noted above, the SHC may be derived from a microphone recording using a microphone array. Various examples of how SHC may be physically acquired from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

The following equation may illustrate how the SHCs may be derived from an object-based description. The coefficients Aₙ^{m}(k) for the soundfield corresponding to an individual audio object may be expressed as:

Aₙ^{m}(k)=g(ω)(−4πik)hₙ⁽²⁾((krₛ)Yₙ^{m*}(θₛ,φₛ)

where i is \sqrt{−1}, hₙ⁽²⁾(⋅) is the spherical Hankel function (of the second kind) of order n, and {rₛ, θₛ, φₛ} is the location of the object. Knowing the object source energy g(ω) as a function of frequency (e.g., using time-frequency analysis techniques, such as performing a fast Fourier transform on the pulse code modulated—PCM—stream) may enable conversion of each PCM object and the corresponding location into the SHC Aₙ^{m}(k). Further, it can be shown (since the above is a linear and orthogonal decomposition) that the Aₙ^{m}(k) coefficients for each object are additive. In this manner, a number of PCM objects can be represented by the Aₙ^{m}(k) coefficients (e.g., as a sum of the coefficient vectors for the individual objects). The coefficients may contain information about the soundfield (the pressure as a function of 3D coordinates), and the above represents the transformation from individual objects to a representation of the overall soundfield, in the vicinity of the observation point {rᵣ,θᵣ, φᵣ}.

Computer-mediated reality systems (which may also be referred to as “extended reality systems,” or “XR systems”) are being developed to take advantage of many of the potential benefits provided by ambisonic coefficients. For example, ambisonic coefficients may represent a soundfield in three dimensions in a manner that potentially enables accurate three-dimensional (3D) localization of sound sources within the soundfield. As such, XR devices may render the ambisonic coefficients to speaker feeds that, when played via one or more speakers, accurately reproduce the soundfield.

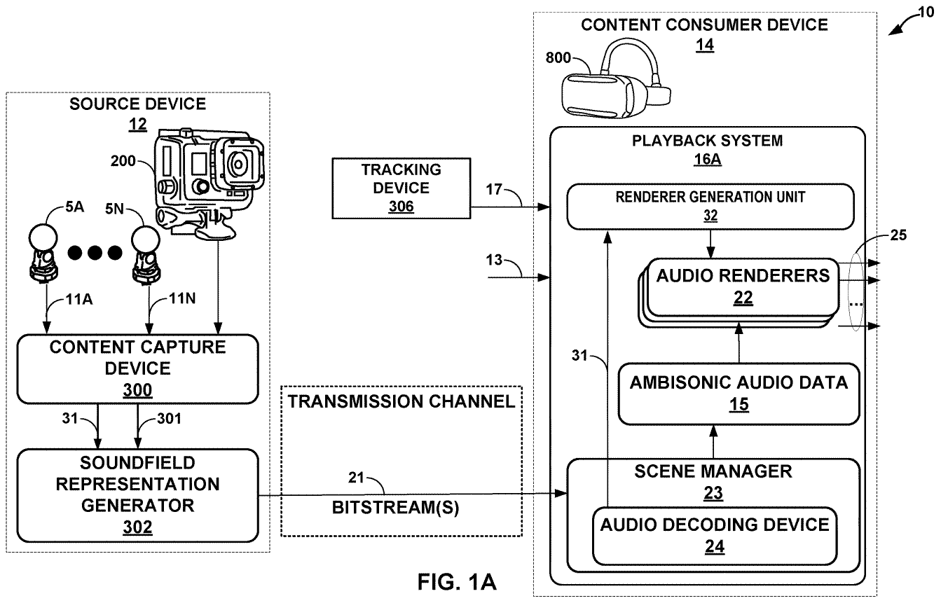

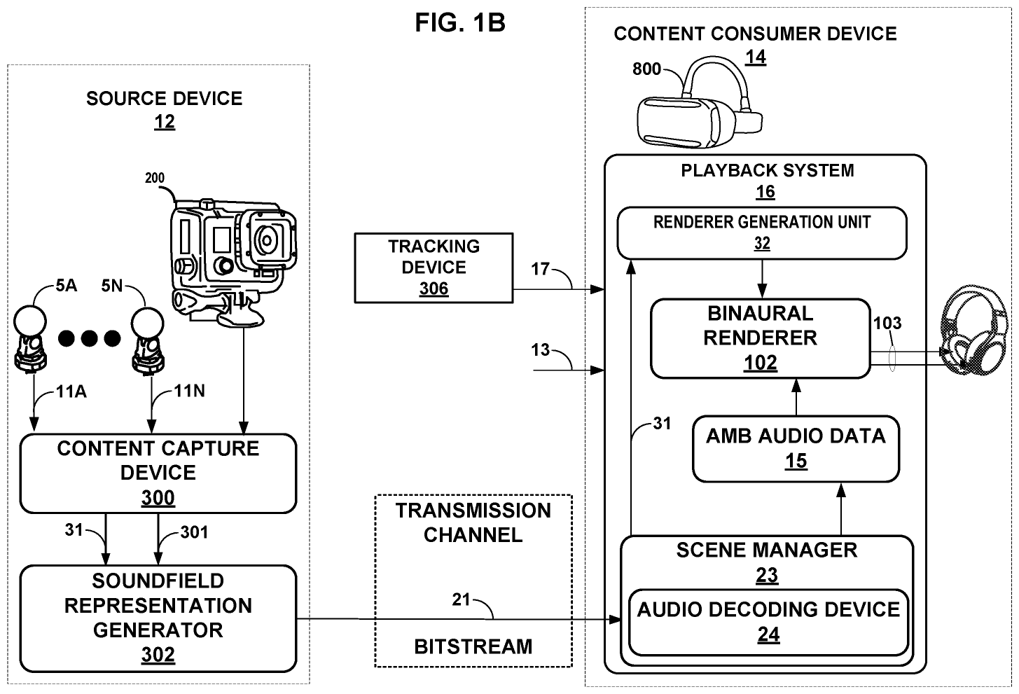

The use of ambisonic coefficients for XR may enable development of a number of use cases that rely on the more immersive soundfields provided by the ambisonic coefficients, particularly for computer gaming applications and live visual streaming applications. In these highly dynamic use cases that rely on low latency reproduction of the soundfield, the XR devices may prefer ambisonic coefficients over other representations that are more difficult to manipulate or involve complex rendering. More information regarding these use cases is provided below with respect to FIGS. 1A and 1B.

While described in this disclosure with respect to the VR device, various aspects of the techniques may be performed in the context of other devices, such as a mobile device. In this instance, the mobile device (such as a so-called smartphone) may present the displayed world via a screen, which may be mounted to the head of the user 102 or viewed as would be done when normally using the mobile device. As such, any information on the screen can be part of the mobile device. The mobile device may be able to provide tracking information and thereby allow for both a VR experience (when head mounted) and a normal experience to view the displayed world, where the normal experience may still allow the user to view the displayed world proving a VR-lite-type experience (e.g., holding up the device and rotating or translating the device to view different portions of the displayed world).

This disclosure may provide for scaling audio sources in extended reality systems. Rather than require users to only operate extended reality systems in locations that permit one-to-one correspondence in terms of spacing with a source location (or in other words space) at which the extended reality scene was captured and/or for which the extended reality scene was generated, various aspects of the techniques enable an extended reality system to scale a source location to accommodate a playback location. As such, if the source location includes microphones that are spaced 10 meters (10 M) apart, the extended reality system may scale that spacing resolution of 10 M to accommodate a scale of a playback location using a scaling factor that is determined based on a source dimension defining a size of the source location and a playback dimension defining a size of a playback location.

Using the scaling provided in accordance with various aspects of the techniques described in this disclosure, the extended reality system may improve reproduction of the soundfield to modify a location of audio sources to accommodate the size of the playback space. In enabling such scaling, the extended reality system may improve an immersive experience for the user when consuming the extended reality scene given that the extended reality scene more closely matches the playback space. The user may then experience the entirety of the extended reality scene safely within the confines of the permitted playback space. In this respect, the techniques may improve operation of the extended reality system itself.

FIGS. 1A and 1B are diagrams illustrating systems that may perform various aspects of the techniques described in this disclosure. As shown in the example of FIG. 1A, system 10 includes a source device 12 and a content consumer device 14. While described in the context of the source device 12 and the content consumer device 14, the techniques may be implemented in any context in which any hierarchical representation of a soundfield is encoded to form a bitstream representative of the audio data. Moreover, the source device 12 may represent any form of computing device capable of generating hierarchical representation of a soundfield, and is generally described herein in the context of being a VR content creator device. Likewise, the content consumer device 14 may represent any form of computing device capable of implementing the audio stream interpolation techniques described in this disclosure as well as audio playback, and is generally described herein in the context of being a VR client device.

The source device 12 may be operated by an entertainment company or other entity that may generate multi-channel audio content for consumption by operators of content consumer devices, such as the content consumer device 14. In many VR scenarios, the source device 12 generates audio content in conjunction with visual content. The source device 12 includes a content capture device 300 and a content soundfield representation generator 302.

The content capture device 300 may be configured to interface or otherwise communicate with one or more microphones 5A-5N (“microphones 5”). The microphones 5 may represent an Eigenmike® or other type of 3D audio microphone capable of capturing and representing the soundfield as corresponding scene-based audio data 11A-11N (which may also be referred to as ambisonic coefficients 11A-11N or “ambisonic coefficients 11”). In the context of scene-based audio data 11 (which is another way to refer to the ambisonic coefficients 11”), each of the microphones 5 may represent a cluster of microphones arranged within a single housing according to set geometries that facilitate generation of the ambisonic coefficients 11. As such, the term microphone may refer to a cluster of microphones (which are actually geometrically arranged transducers) or a single microphone (which may be referred to as a spot microphone or spot transducer).

The ambisonic coefficients 11 may represent one example of an audio stream. As such, the ambisonic coefficients 11 may also be referred to as audio streams 11. Although described primarily with respect to the ambisonic coefficients 11, the techniques may be performed with respect to other types of audio streams, including pulse code modulated (PCM) audio streams, channel-based audio streams, object-based audio streams, etc.

The content capture device 300 may, in some examples, include an integrated microphone that is integrated into the housing of the content capture device 300. The content capture device 300 may interface wirelessly or via a wired connection with the microphones 5. Rather than capture, or in conjunction with capturing, audio data via the microphones 5, the content capture device 300 may process the ambisonic coefficients 11 after the ambisonic coefficients 11 are input via some type of removable storage, wirelessly, and/or via wired input processes, or alternatively or in conjunction with the foregoing, generated or otherwise created (from stored sound samples, such as is common in gaming applications, etc.). As such, various combinations of the content capture device 300 and the microphones 5 are possible.

The content capture device 300 may also be configured to interface or otherwise communicate with the soundfield representation generator 302. The soundfield representation generator 302 may include any type of hardware device capable of interfacing with the content capture device 300. The soundfield representation generator 302 may use the ambisonic coefficients 11 provided by the content capture device 300 to generate various representations of the same soundfield represented by the ambisonic coefficients 11.

For instance, to generate the different representations of the soundfield using ambisonic coefficients (which again is one example of the audio streams), the soundfield representation generator 24 may use a coding scheme for ambisonic representations of a soundfield, referred to as Mixed Order Ambisonics (MOA) as discussed in more detail in U.S. application Ser. No. 15/672,058, entitled “MIXED-ORDER AMBISONICS (MOA) AUDIO DATA FO COMPUTER-MEDIATED REALITY SYSTEMS,” filed Aug. 8, 2017, and published as U.S. patent publication no. 20190007781 on Jan. 3, 2019.

To generate a particular MOA representation of the soundfield, the soundfield representation generator 24 may generate a partial subset of the full set of ambisonic coefficients (where the term “subset” is used not in the strict mathematical sense to include zero or more, if not all, of the full set, but instead may refer to one or more, but not all of the full set). For instance, each MOA representation generated by the soundfield representation generator 24 may provide precision with respect to some areas of the soundfield, but less precision in other areas. In one example, an MOA representation of the soundfield may include eight (8) uncompressed ambisonic coefficients, while the third order ambisonic representation of the same soundfield may include sixteen (16) uncompressed ambisonic coefficients. As such, each MOA representation of the soundfield that is generated as a partial subset of the ambisonic coefficients may be less storage-intensive and less bandwidth intensive (if and when transmitted as part of the bitstream 27 over the illustrated transmission channel) than the corresponding third order ambisonic representation of the same soundfield generated from the ambisonic coefficients.

Although described with respect to MOA representations, the techniques of this disclosure may also be performed with respect to first-order ambisonic (FOA) representations in which all of the ambisonic coefficients associated with a first order spherical basis function and a zero order spherical basis function are used to represent the soundfield. In other words, rather than represent the soundfield using a partial, non-zero subset of the ambisonic coefficients, the soundfield representation generator 302 may represent the soundfield using all of the ambisonic coefficients for a given order N, resulting in a total of ambisonic coefficients equaling (N+1)².

In this respect, the ambisonic audio data (which is another way to refer to the ambisonic coefficients in either MOA representations or full order representations, such as the first-order representation noted above) may include ambisonic coefficients associated with spherical basis functions having an order of one or less (which may be referred to as “1^{st} order ambisonic audio data”), ambisonic coefficients associated with spherical basis functions having a mixed order and suborder (which may be referred to as the “MOA representation” discussed above), or ambisonic coefficients associated with spherical basis functions having an order greater than one (which is referred to above as the “full order representation”).

The content capture device 300 may, in some examples, be configured to wirelessly communicate with the soundfield representation generator 302. In some examples, the content capture device 300 may communicate, via one or both of a wireless connection or a wired connection, with the soundfield representation generator 302. Via the connection between the content capture device 300 and the soundfield representation generator 302, the content capture device 300 may provide content in various forms of content, which, for purposes of discussion, are described herein as being portions of the ambisonic coefficients 11.

In some examples, the content capture device 300 may leverage various aspects of the soundfield representation generator 302 (in terms of hardware or software capabilities of the soundfield representation generator 302). For example, the soundfield representation generator 302 may include dedicated hardware configured to (or specialized software that when executed causes one or more processors to) perform psychoacoustic audio encoding (such as a unified speech and audio coder denoted as “USAC” set forth by the Moving Picture Experts Group (MPEG), the MPEG-H 3D audio coding standard, the MPEG-I Immersive Audio standard, or proprietary standards, such as AptX™ (including various versions of AptX such as enhanced AptX—E-AptX, AptX live, AptX stereo, and AptX high definition—AptX-HD), advanced audio coding (AAC), Audio Codec 3 (AC-3), Apple Lossless Audio Codec (ALAC), MPEG-4 Audio Lossless Streaming (ALS), enhanced AC-3, Free Lossless Audio Codec (FLAC), Monkey's Audio, MPEG-1 Audio Layer II (MP2), MPEG-1 Audio Layer III (MP3), Opus, and Windows Media Audio (WMA).

The content capture device 300 may not include the psychoacoustic audio encoder dedicated hardware or specialized software and instead provide audio aspects of the content 301 in a non-psychoacoustic audio coded form. The soundfield representation generator 302 may assist in the capture of content 301 by, at least in part, performing psychoacoustic audio encoding with respect to the audio aspects of the content 301.

The soundfield representation generator 302 may also assist in content capture and transmission by generating one or more bitstreams 21 based, at least in part, on the audio content (e.g., MOA representations, third order ambisonic representations, and/or first order ambisonic representations) generated from the ambisonic coefficients 11. The bitstream 21 may represent a compressed version of the ambisonic coefficients 11 (and/or the partial subsets thereof used to form MOA representations of the soundfield) and any other different types of the content 301 (such as a compressed version of spherical visual data, image data, or text data).

The soundfield representation generator 302 may generate the bitstream 21 for transmission, as one example, across a transmission channel, which may be a wired or wireless channel, a data storage device, or the like. The bitstream 21 may represent an encoded version of the ambisonic coefficients 11 (and/or the partial subsets thereof used to form MOA representations of the soundfield) and may include a primary bitstream and another side bitstream, which may be referred to as side channel information. In some instances, the bitstream 21 representing the compressed version of the ambisonic coefficients 11 may conform to bitstreams produced in accordance with the MPEG-H 3D audio coding standard and/or an MPEG-I standard for “Coded Representations of Immersive Media.”

The content consumer device 14 may be operated by an individual, and may represent a VR client device. Although described with respect to a VR client device, content consumer device 14 may represent other types of devices, such as an augmented reality (AR) client device, a mixed reality (MR) client device (or any other type of head-mounted display device or extended reality—XR—device), a standard computer, a headset, headphones, or any other device capable of tracking head movements and/or general translational movements of the individual operating the client consumer device 14. As shown in the example of FIG. 1A, the content consumer device 14 includes an audio playback system 16A, which may refer to any form of audio playback system capable of rendering ambisonic coefficients (whether in form of first order, second order, and/or third order ambisonic representations and/or MOA representations) for playback as multi-channel audio content.

The content consumer device 14 may retrieve the bitstream 21 directly from the source device 12. In some examples, the content consumer device 12 may interface with a network, including a fifth generation (5G) cellular network, to retrieve the bitstream 21 or otherwise cause the source device 12 to transmit the bitstream 21 to the content consumer device 14.

While shown in FIG. 1A as being directly transmitted to the content consumer device 14, the source device 12 may output the bitstream 21 to an intermediate device positioned between the source device 12 and the content consumer device 14. The intermediate device may store the bitstream 21 for later delivery to the content consumer device 14, which may request the bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding visual data bitstream) to subscribers, such as the content consumer device 14, requesting the bitstream 21.

Alternatively, the source device 12 may store the bitstream 21 to a storage medium, such as a compact disc, a digital visual disc, a high definition visual disc or other storage media, most of which are capable of being read by a computer and therefore may be referred to as computer-readable storage media or non-transitory computer-readable storage media. In this context, the transmission channel may refer to the channels by which content stored to the mediums are transmitted (and may include retail stores and other store-based delivery mechanism). In any event, the techniques of this disclosure should not therefore be limited in this respect to the example of FIG. 1A.

As noted above, the content consumer device 14 includes the audio playback system 16. The audio playback system 16 may represent any system capable of playing back multi-channel audio data. The audio playback system 16A may include a number of different audio renderers 22. The renderers 22 may each provide for a different form of audio rendering, where the different forms of rendering may include one or more of the various ways of performing vector-base amplitude panning (VBAP), and/or one or more of the various ways of performing soundfield synthesis. As used herein, “A and/or B” means “A or B”, or both “A and B”.

The audio playback system 16A may further include an audio decoding device 24. The audio decoding device 24 may represent a device configured to decode bitstream 21 to output reconstructed ambisonic coefficients 11A′-11N′ (which may form the full first, second, and/or third order ambisonic representation or a subset thereof that forms an MOA representation of the same soundfield or decompositions thereof, such as the predominant audio signal, ambient ambisonic coefficients, and the vector based signal described in the MPEG-H 3D Audio Coding Standard and/or the MPEG-I Immersive Audio standard).

As such, the ambisonic coefficients 11A′-11N′ (“ambisonic coefficients 11′”) may be similar to a full set or a partial subset of the ambisonic coefficients 11, but may differ due to lossy operations (e.g., quantization) and/or transmission via the transmission channel. The audio playback system 16 may, after decoding the bitstream 21 to obtain the ambisonic coefficients 11′, obtain ambisonic audio data 15 from the different streams of ambisonic coefficients 11′, and render the ambisonic audio data 15 to output speaker feeds 25. The speaker feeds 25 may drive one or more speakers (which are not shown in the example of FIG. 1A for ease of illustration purposes). Ambisonic representations of a soundfield may be normalized in a number of ways, including N3D, SN3D, FuMa, N2D, or SN2D.

To select the appropriate renderer or, in some instances, generate an appropriate renderer, the audio playback system 16A may obtain loudspeaker information 13 indicative of a number of loudspeakers and/or a spatial geometry of the loudspeakers. In some instances, the audio playback system 16A may obtain the loudspeaker information 13 using a reference microphone and outputting a signal to activate (or, in other words, drive) the loudspeakers in such a manner as to dynamically determine, via the reference microphone, the loudspeaker information 13. In other instances, or in conjunction with the dynamic determination of the loudspeaker information 13, the audio playback system 16A may prompt a user to interface with the audio playback system 16A and input the loudspeaker information 13.

The audio playback system 16A may select one of the audio renderers 22 based on the loudspeaker information 13. In some instances, the audio playback system 16A may, when none of the audio renderers 22 are within some threshold similarity measure (in terms of the loudspeaker geometry) to the loudspeaker geometry specified in the loudspeaker information 13, generate the one of audio renderers 22 based on the loudspeaker information 13. The audio playback system 16A may, in some instances, generate one of the audio renderers 22 based on the loudspeaker information 13 without first attempting to select an existing one of the audio renderers 22.

When outputting the speaker feeds 25 to headphones, the audio playback system 16A may utilize one of the renderers 22 that provides for binaural rendering using head-related transfer functions (HRTF) or other functions capable of rendering to left and right speaker feeds 25 for headphone speaker playback. The terms “speakers” or “transducer” may generally refer to any speaker, including loudspeakers, headphone speakers, etc. One or more speakers may then playback the rendered speaker feeds 25.

Although described as rendering the speaker feeds 25 from the ambisonic audio data 15, reference to rendering of the speaker feeds 25 may refer to other types of rendering, such as rendering incorporated directly into the decoding of the ambisonic audio data 15 from the bitstream 21. An example of the alternative rendering can be found in Annex G of the MPEG-H 3D audio coding standard, where rendering occurs during the predominant signal formulation and the background signal formation prior to composition of the soundfield. As such, reference to rendering of the ambisonic audio data 15 should be understood to refer to both rendering of the actual ambisonic audio data 15 or decompositions or representations thereof of the ambisonic audio data 15 (such as the above noted predominant audio signal, the ambient ambisonic coefficients, and/or the vector-based signal—which may also be referred to as a V-vector).

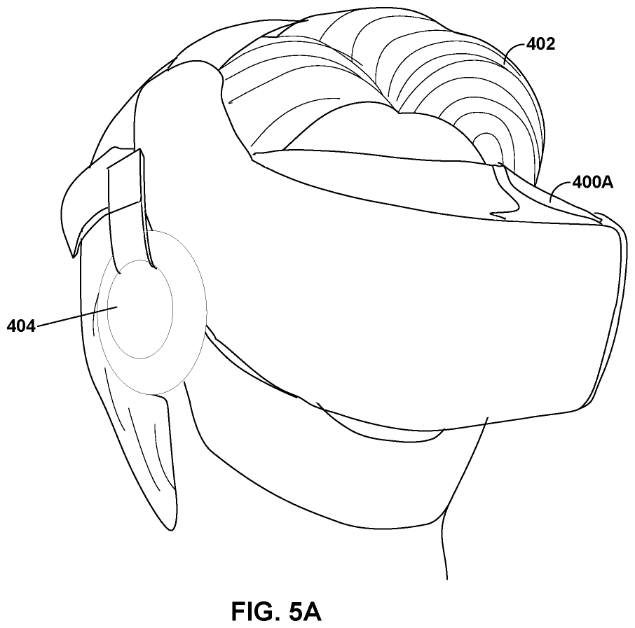

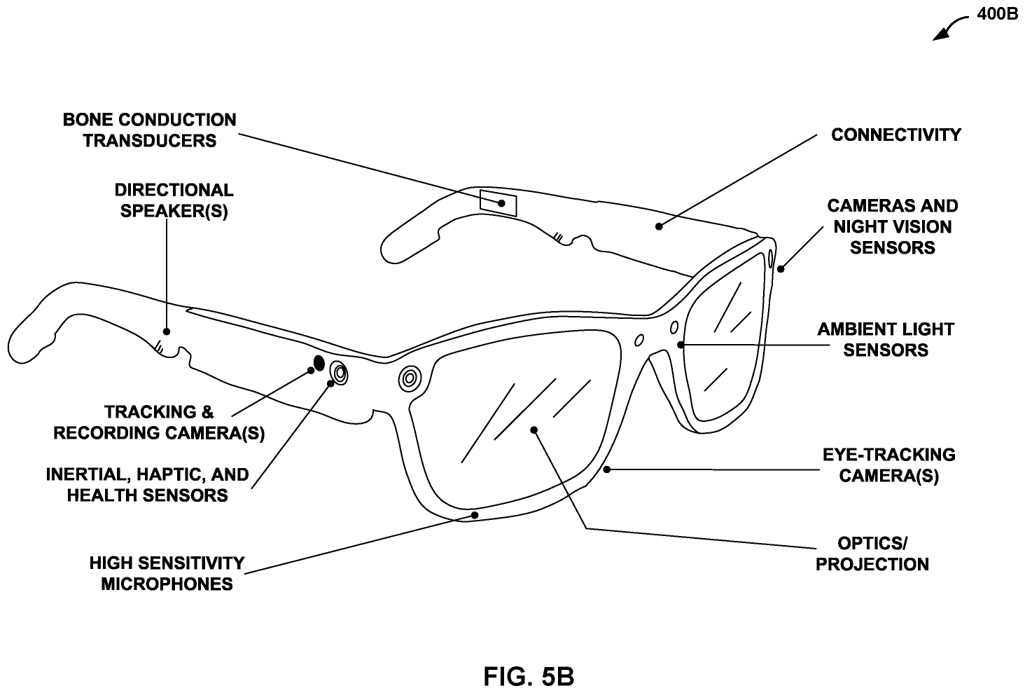

As described above, the content consumer device 14 may represent a VR device in which a human wearable display is mounted in front of the eyes of the user operating the VR device. FIGS. 5A and 5B are diagrams illustrating examples of VR devices 400A and 400B. In the example of FIG. 5A, the VR device 400A is coupled to, or otherwise includes, headphones 404, which may reproduce a soundfield represented by the ambisonic audio data 15 (which is another way to refer to ambisonic coefficients 15) through playback of the speaker feeds 25. The speaker feeds 25 may represent an analog or digital signal capable of causing a membrane within the transducers of headphones 404 to vibrate at various frequencies. Such a process is commonly referred to as driving the headphones 404.

Visual, audio, and other sensory data may play important roles in the VR experience. To participate in a VR experience, a user 402 may wear the VR device 400A (which may also be referred to as a VR headset 400A) or other wearable electronic device. The VR client device (such as the VR headset 400A) may track head movement of the user 402, and adapt the visual data shown via the VR headset 400A to account for the head movements, providing an immersive experience in which the user 402 may experience a virtual world shown in the visual data in visual three dimensions.

While VR (and other forms of AR and/or MR, which may generally be referred to as a computer mediated reality device) may allow the user 402 to reside in the virtual world visually, often the VR headset 400A may lack the capability to place the user in the virtual world audibly. In other words, the VR system (which may include a computer responsible for rendering the visual data and audio data—that is not shown in the example of FIG. 5A for ease of illustration purposes, and the VR headset 400A) may be unable to support full three dimension immersion audibly.

FIG. 5B is a diagram illustrating an example of a wearable device 400B that may operate in accordance with various aspect of the techniques described in this disclosure. In various examples, the wearable device 400B may represent a VR headset (such as the VR headset 400A described above), an AR headset, an MR headset, or any other type of XR headset. Augmented Reality “AR” may refer to computer rendered image or data that is overlaid over the real world where the user is actually located. Mixed Reality “MR” may refer to computer rendered image or data that is world locked to a particular location in the real world, or may refer to a variant on VR in which part computer rendered 3D elements and part photographed real elements are combined into an immersive experience that simulates the user's physical presence in the environment. Extended Reality “XR” may represent a catchall term for VR, AR, and MR. More information regarding terminology for XR can be found in a document by Jason Peterson, entitled “Virtual Reality, Augmented Reality, and Mixed Reality Definitions,” and dated Jul. 7, 2017.

The wearable device 400B may represent other types of devices, such as a watch (including so-called “smart watches”), glasses (including so-called “smart glasses”), headphones (including so-called “wireless headphones” and “smart headphones”), smart clothing, smart jewelry, and the like. Whether representative of a VR device, a watch, glasses, and/or headphones, the wearable device 400B may communicate with the computing device supporting the wearable device 400B via a wired connection or a wireless connection.

In some instances, the computing device supporting the wearable device 400B may be integrated within the wearable device 400B and as such, the wearable device 400B may be considered as the same device as the computing device supporting the wearable device 400B. In other instances, the wearable device 400B may communicate with a separate computing device that may support the wearable device 400B. In this respect, the term “supporting” should not be understood to require a separate dedicated device but that one or more processors configured to perform various aspects of the techniques described in this disclosure may be integrated within the wearable device 400B or integrated within a computing device separate from the wearable device 400B.

For example, when the wearable device 400B represents an example of the VR device 400B, a separate dedicated computing device (such as a personal computer including the one or more processors) may render the audio and visual content, while the wearable device 400B may determine the translational head movement upon which the dedicated computing device may render, based on the translational head movement, the audio content (as the speaker feeds) in accordance with various aspects of the techniques described in this disclosure. As another example, when the wearable device 400B represents smart glasses, the wearable device 400B may include the one or more processors that both determine the translational head movement (by interfacing within one or more sensors of the wearable device 400B) and render, based on the determined translational head movement, the speaker feeds.

As shown, the wearable device 400B includes one or more directional speakers, and one or more tracking and/or recording cameras. In addition, the wearable device 400B includes one or more inertial, haptic, and/or health sensors, one or more eye-tracking cameras, one or more high sensitivity audio microphones, and optics/projection hardware. The optics/projection hardware of the wearable device 400B may include durable semi-transparent display technology and hardware.

The wearable device 400B also includes connectivity hardware, which may represent one or more network interfaces that support multimode connectivity, such as 4G communications, 5G communications, Bluetooth, etc. The wearable device 400B also includes one or more ambient light sensors, and bone conduction transducers. In some instances, the wearable device 400B may also include one or more passive and/or active cameras with fisheye lenses and/or telephoto lenses. Although not shown in FIG. 5B, the wearable device 400B also may include one or more light emitting diode (LED) lights. In some examples, the LED light(s) may be referred to as “ultra bright” LED light(s). The wearable device 400B also may include one or more rear cameras in some implementations. It will be appreciated that the wearable device 400B may exhibit a variety of different form factors.

Furthermore, the tracking and recording cameras and other sensors may facilitate the determination of translational distance. Although not shown in the example of FIG. 5B, wearable device 400B may include other types of sensors for detecting translational distance.

Although described with respect to particular examples of wearable devices, such as the VR device 400B discussed above with respect to the examples of FIG. 5B and other devices set forth in the examples of FIGS. 1A and 1B, a person of ordinary skill in the art would appreciate that descriptions related to FIGS. 1A-5B may apply to other examples of wearable devices. For example, other wearable devices, such as smart glasses, may include sensors by which to obtain translational head movements. As another example, other wearable devices, such as a smart watch, may include sensors by which to obtain translational movements. As such, the techniques described in this disclosure should not be limited to a particular type of wearable device, but any wearable device may be configured to perform the techniques described in this disclosure.

In the example of FIG. 1A, the source device 12 further includes a camera 200. The camera 200 may be configured to capture visual data, and provide the captured raw visual data to the content capture device 300. The content capture device 300 may provide the visual data to another component of the source device 12, for further processing into viewport-divided portions.

The content consumer device 14 also includes the wearable device 800. It will be understood that, in various implementations, the wearable device 800 may be included in, or externally coupled to, the content consumer device 14. As discussed above with respect to FIGS. 5A and 5B, the wearable device 800 includes display hardware and speaker hardware for outputting visual data (e.g., as associated with various viewports) and for rendering audio data.

In any event, the audio aspects of VR have been classified into three separate categories of immersion. The first category provides the lowest level of immersion, and is referred to as three degrees of freedom (3DOF). 3DOF refers to audio rendering that accounts for movement of the head in the three degrees of freedom (yaw, pitch, and roll), thereby allowing the user to freely look around in any direction. 3DOF, however, cannot account for translational head movements in which the head is not centered on the optical and acoustical center of the soundfield.

The second category, referred to 3DOF plus (3DOF+), provides for the three degrees of freedom (yaw, pitch, and roll) in addition to limited spatial translational movements due to the head movements away from the optical center and acoustical center within the soundfield. 3DOF+ may provide support for perceptual effects such as motion parallax, which may strengthen the sense of immersion.

The third category, referred to as six degrees of freedom (6DOF), renders audio data in a manner that accounts for the three degrees of freedom in term of head movements (yaw, pitch, and roll) but also accounts for translation of the user in space (x, y, and z translations). The spatial translations may be induced by sensors tracking the location of the user in the physical world or by way of an input controller.

3DOF rendering is the current state of the art for audio aspects of VR. As such, the audio aspects of VR are less immersive than the visual aspects, thereby potentially reducing the overall immersion experienced by the user, and introducing localization errors (e.g., such as when the auditory playback does not match or correlate exactly to the visual scene).

Although 3DOF rendering is the current state, more immersive audio rendering, such as 3DOF+ and 6DOF rendering, may result in higher complexity in terms of processor cycles expended, memory and bandwidth consumed, etc. Furthermore, rendering for 6DOF may require additional granularity in terms of pose (which may refer to position and/or orientation) that results in the higher complexity, while also complicating certain XR scenarios in terms of asynchronous capture of audio data and visual data.

For example, consider XR scenes that involve live audio data capture (e.g., XR conferences, visual conferences, visual chat, metaverses, XR games, live action events —such as concerts, sports games, symposiums, conferences, and the like, etc.) in which avatars (an example visual object) speak to one another using microphones to capture the live audio and convert such live audio into audio objects (which may also be referred to as audio elements as the audio objects are not necessarily defined in the object format).

In some instances, capture of an XR scene may occur in large physical spaces, such as concert venues, stadiums (e.g., for sports, concerts, symposiums, etc.), conference halls (e.g., for symposiums), etc. that may be larger than a normal playback space, such as a living room, recreation room, television room, bedroom, and the like. That is, a person experiencing an XR scene may not have a physical space that is on the same scale as the capture location.

In VR scenes, a user may teleport to different locations within the capture environment. With the ability to overlay digital content on real world, or in other words physical, spaces (which occurs, for example, in AR), the inability to teleport to different locations (which may refer to virtual locations or, in other words, locations in the XR scene) may result in issues that restrict how the playback space may recreate an immersive experience for such XR scenes. That is, the audio experience may suffer due to scale differences between a content capture space and the playback space, which may prevent users from fully participating in the XR scenes.

In accordance with various aspects of the techniques described in this disclosure, the playback system 16 may scale audio sources in extended reality system 10. Rather than require users to only operate extended reality system 10 in locations that permit one-to-one correspondence in terms of spacing with a source location at which the extended reality scene was captured and/or for which the extended reality scene was generated, various aspects of the techniques enable extended reality system 10 to scale a source location to accommodate a playback location. As such, if the source location includes microphones that are spaced 10 meters (10 M) apart, extended reality system 10 may scale that spacing resolution of 10 M to accommodate a scale of a playback location using a scaling factor (which may also be referred to as a rescaling factor) that is determined based on a source dimension defining a size of the source location and a playback dimension defining a size of a playback location.

In operation, the soundfield representation generator 302 may specify, in the audio bitstream 21, a syntax element indicative of a rescaling factor for the audio element. The rescaling factor may indicating how a location of the audio element is to be rescaled relative to other audio elements. The soundfield representation generator 302 may also specify a syntax element indicating that auto rescale is to be performed for a duration in which the audio element is present for playback. The soundfield representation generator 302 may then output the audio bitstream 21.

The audio playback system 16A may receive the audio bitstream 21 and extract syntax elements indicative of one or more source dimensions associated with a source space for the XR scene. In some instances, the syntax elements may be specified in a side channel of metadata or other extensions to the audio bitstream 21. Regardless, the audio playback system 16A may parse the source dimensions (e.g., as syntax elements) from the audio bitstream 21 or otherwise obtain the source dimensions associated with the source space for the XR scene.

The audio playback system 16A may also obtain a playback dimension (one or more playback dimensions) associated with a physical space in which playback of the audio bitstream 21 is to occur. That is, the audio playback device 16A may interface with a user operating the audio playback device 16A to identify the playback dimensions (e.g., through an interactive user interface in which the user moves around the room to identify the playback dimensions) (and/or via a remote camera mounted to capture playback of the XR scene, via a head-mounted camera to capture playback/interactions of/with the XR scene, etc.).

The audio playback system 16A may then modify, based on the playback dimension an the source dimension, a location associated with the audio element to obtain a modified location for the audio element. In this respect, the audio decoding device 24 may parse the audio element from the audio bitstream 21, which is represented in the example of FIG. 1 as the ambisonic audio data 15 (which may represent one or more audio elements). While described with respect to the ambisonic audio data 15, various other audio data formats may be rescaled according to various aspects of the techniques, where other audio data formats may include object-based formats, channel-based formats, and the like.

In terms of performing audio rescaling, the audio playback system 16A may determine whether a difference between the source dimension and the playback dimension exceeds a threshold difference (e.g., more than 1%, 5%, 10%, 20%, etc. difference between the source dimension and the playback dimension). If the difference between the source dimension and the playback dimension exceeds the different threshold (defined, for example, as 1%, 5%, 10%, 20%, etc.), the audio playback system 16A may then determine the rescaling factor. The audio playback system 16A may determine the rescaling factor as a function of the playback dimension divided by the source dimension.

In instances of linear rescaling, the audio playback system 16A may determine the rescaling factor as the playback dimension divided by the source dimension. For example, assuming the source dimension is 20 M and the playback dimension is 6 M, the audio playback system 16A may compute the rescaling factor as 6 M/20 M, which equals 0.3 or 30% as the rescaling factor. The audio playback system 16A may apply the audio factor (e.g., 30%) when invoking the scene manager 23.

The audio playback system 16A may invoke the scene manager 23, passing the rescaling factor to the scene manager 23. The scene manager 23 may apply the rescaling factor when processing the audio elements extracted from the audio bitstream 21. The scene manager 23 may modify metadata defining a location of the audio element in the XR scene, rescaling metadata defining the location of the audio object to obtain the modified location of the audio object. The scene manager 23 may pass the modified location to the audio renderer 22, which may render, based on the modified location for the audio element, the audio element to the speaker feeds 25. The audio renderers 22 may then output the speaker feeds 25 for playback by the audio playback system 16A (which may include one or more loudspeakers configured to reproduce, based on the speaker feeds 25, a soundfield.

The audio decoding device 24 may parse the above noted syntax elements indicating a rescale factor and an audio rescale is to be performed. When the rescale factor is specified in the manner noted above, the audio playback system 16A may obtain the rescale factor directly from the audio bitstream 21 (meaning, in this instance, without computing the rescale factor as a function of the playback dimension being divided by the source dimension). The audio playback system 16A may then apply the rescale factor in the manner noted above to obtain the modified location of the audio element.

When processing the syntax element indicative of auto rescale, the audio playback system 16A may refrain from rescaling audio elements associated with the auto rescale syntax element indicating that auto rescale is not to be performed. Otherwise, the audio playback system 16A may process audio elements associated with the audio rescale syntax element indicating that auto rescale is to be performed using various aspects of the techniques described in this disclosure for performing rescale. The auto rescale syntax element may configure the audio playback system 16A to continually apply the rescale factor to the associated audio element while the associated audio element is present in the XR scene.

Using the scaling (which is another way to refer to rescaling) provided in accordance with various aspects of the techniques described in this disclosure, the audio playback system 16A (which is another way to refer to an XR playback system, a playback system, etc.) may improve reproduction of the soundfield to modify a location of audio sources (which is another way to refer to the audio elements parsed from the audio bitstream 21) to accommodate the size of the playback space. In enabling such scaling, the audio playback system 16A may improve an immersive experience for the user when consuming the XR scene given that the XR scene more closely matches the playback space. The user may then experience the entirety of the XR scene safely within the confines of the permitted playback space. In this respect, the techniques may improve operation of the audio playback system 16A itself.

FIG. 1B is a block diagram illustrating another example system 100 configured to perform various aspects of the techniques described in this disclosure. The system 100 is similar to the system 10 shown in FIG. 1A, except that the audio renderers 22 shown in FIG. 1A are replaced with a binaural renderer 102 capable of performing binaural rendering using one or more HRTFs or the other functions capable of rendering to left and right speaker feeds 103.

The audio playback system 16B may output the left and right speaker feeds 103 to headphones 104, which may represent another example of a wearable device and which may be coupled to additional wearable devices to facilitate reproduction of the soundfield, such as a watch, the VR headset noted above, smart glasses, smart clothing, smart rings, smart bracelets or any other types of smart jewelry (including smart necklaces), and the like. The headphones 104 may couple wirelessly or via wired connection to the additional wearable devices.

Additionally, the headphones 104 may couple to the audio playback system 16 via a wired connection (such as a standard 3.5 mm audio jack, a universal system bus (USB) connection, an optical audio jack, or other forms of wired connection) or wirelessly (such as by way of a Bluetooth™ connection, a wireless network connection, and the like). The headphones 104 may recreate, based on the left and right speaker feeds 103, the soundfield represented by the ambisonic coefficients 11. The headphones 104 may include a left headphone speaker and a right headphone speaker which are powered (or, in other words, driven) by the corresponding left and right speaker feeds 103.

Although described with respect to a VR device as shown in the example of FIGS. 5A and 5B, the techniques may be performed by other types of wearable devices, including watches (such as so-called “smart watches”), glasses (such as so-called “smart glasses”), headphones (including wireless headphones coupled via a wireless connection, or smart headphones coupled via wired or wireless connection), and any other type of wearable device. As such, the techniques may be performed by any type of wearable device by which a user may interact with the wearable device while worn by the user.

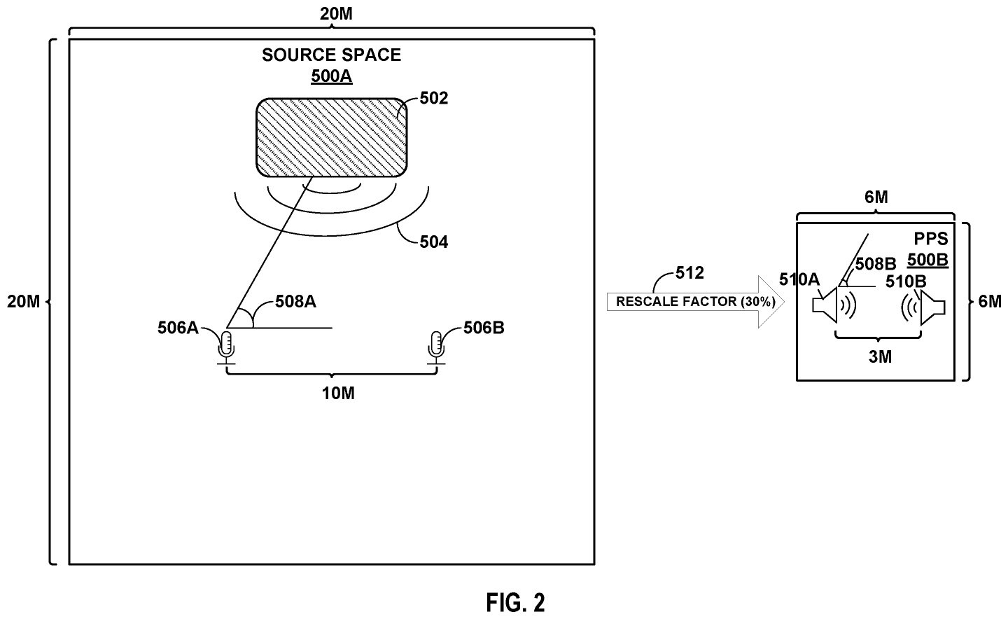

FIG. 2 is a block diagram illustrating example physical spaces in which various aspects of the rescaling techniques are performed in order to facilitate increased immersion while consuming extended reality scenes. In the example of FIG. 2, a source space 500A and a physical playback space (PPS) 500B is shown.

The source space 500A represents a concert venue (in this example) from which a stage 502 emits an audio soundfield 504 via loudspeakers (which are not shown in the example of FIG. 2 for ease of illustration purposes). The source space 500A also includes microphones 506A and 506B (“microphones 506”) that capture audio data representative of the audio soundfield 504. The content capture device 300 may capture the audio data representative of the audio soundfield 504 in various audio formats, such as a scene-based format (that may be defined via HOA audio formats), object-based formats, channel-based formats, and the like.

The soundfield representation generator 302 may generate, based on the audio data, the audio bitstreams 21 that specifies audio elements (in one or more of the audio formats noted above). The soundfield representation generator 302 may specify, in the audio bitstreams 21, the above noted syntax elements, such as the rescale syntax element that specifies a rescale factor to translate a position (or, in other words, location) of audio elements with respect to (often denoted as “w.r.t.”) the associated audio element and an auto rescale syntax element that specifies whether or not (e.g., a Boolean value) to generate a rescale factor based on environment dimensions (e.g., the dimensions of PPS 500B).

In the example of FIG. 2, the source space 500A is square with dimensions of 20 M in width and 20 M in length. Although not shown, the source space 500A may also include a height dimension (e.g., 20 M). The soundfield representation generator 302 may specify, in the audio bitstream 21, one or more syntax elements that specify one or more of the width, space, and/or height of the source space 500A. The soundfield representation generator 302 may specify the one or more syntax elements that specify one or more of the width, space, and/or height of the source space 500A using any form of syntax elements, including referential syntax elements that indicate one or more dimensions are the same as other dimensions of the source space 500A.

Microphones 506 may capture the audio data representative of the audio soundfield 504 in a manner that preserves an orientation, incidence of arrival, etc. of how the soundfield 504 arrived at each individual microphone 506. Microphones 506 may represent an Eigenmike® or other 3D microphone capable of capturing audio data in 360 degrees to fully represent the soundfield 504. In this respect, microphones 506 may represent an example of microphones 5 shown in the example of FIGS. 1A and 1B.

Microphones 506 may therefore generate audio data reflective of a particular aspect of the soundfield 504, including an angle of incidence 508A (for microphone 506A, but there is also an angle of incidence 508B that is not shown for ease of illustration purposes with respect to microphone 506B).

In this way, the soundfield generator device 302 may generate the audio bitstream 21 to represent the audio elements captured by microphones 506 in 3D so that reproduction of the audio soundfield 504 may occur in 6DOF systems that provide a highly immersive experience. However, the PPS 500B has significantly different dimensions in that the dimensions for PPS 500B are 6 M for width and 6 M for length (and possibly 6 M for height or some other height).

In this example, the microphones in the source space 500A are located approximately 10 M apart, while the PPS 500B includes loudspeakers 510A and 510B (“loudspeakers 510”) spaced about, or approximately, 3 M apart. The audio playback system 16A may receive the audio bitstream 21 and parse (e.g., by invoking the audio decoding device 24) the audio elements representative of the soundfield 504 from the audio bitstream 21. The audio playback system 16A may also parse (e.g., by invoking the audio decoding device 24) the various syntax elements noted above with respect to the element relative rescale and auto rescale.

In initializing the audio playback system 16A for playback in the PPS 500B, the user of the content consumer device 14 may enter the dimensions (e.g., one or more of height, length, and width) of the PPS 500B via, as one example, a user interface or via having the user move about the PPS 500B. In some examples, the content consumer device 14 may automatically determine the dimensions of the PPS 500B (e.g., using a camera, an infrared sensing device, radar, lidar, ultrasound, etc.).

In any event, the audio playback system 16A may obtain both the dimensions of the source space 500A as well as the dimensions of the PPS 500B. The audio playback system 16A may next process the syntax elements for relative rescale and auto rescale to identify how and which audio elements specified in the audio bitstream 21 are to be resealed. Assuming in this example that the audio soundfield 504 is to be rescaled as indicated by the syntax elements, the audio playback system 16A may determined, based on the dimension of the source space 500A and the dimension of the PPS 500B, a rescale factor 512.

In the example of FIG. 2, the audio playback system 16A may determine the rescale factor as the width of the PPS 500B (6 M) divided by the width of the source space 500A (20 M), which results in a rescale factor of 0.3 or, in other words, 30%. The audio playback system 16A may next modify a location of the audio element representing the soundfield 504 captured by the microphone 506A to obtain a modified location of the soundfield 504 captured by the microphone 506A that is 30% closer to a reference location (e.g., a reference location for the center (0, 0, 0) of the XR scene, or in other words, an XR world) compared to a location of the microphone 506A relative of the center of the XR scene/world.

That is, the audio playback system 16A may multiply the location of the audio element representing the soundfield 504 as captured by the microphone 506A by the rescale factor to obtain the modified location of the audio element representing the soundfield 504 as captured by the microphone 506A. Given that the approximate dimensions of the source space 500A are uniform compared to the dimensions of the PPS 500B (meaning that the width and length of the source space 500A are linearly equivalent in proportion to the dimensions of the PPS 500B), the audio playback system 16A may apply the rescale factor to modify the location of the audio element representing the audio soundfield 504 as captured by the microphone 506A without altering an angle of incidence 508B during reproduction/playback by loudspeakers 510.

Using the scaling (which is another way to refer to rescaling) provided in accordance with various aspects of the techniques described in this disclosure, the audio playback system 16A (which is another way to refer to an XR playback system, a playback system, etc.) may improve reproduction of the soundfield to modify a location of audio sources (which is another way to refer to the audio elements parsed from the audio bitstream 21) to accommodate the size of the PPS 500B. In enabling such scaling, the audio playback system 16A may improve an immersive experience for the user when consuming the XR scene given that the XR scene more closely matches the playback space. The user may then experience the entirety of the XR scene safely within the confines of the permitted playback space. In this respect, the techniques may improve operation of the audio playback system 16A itself.

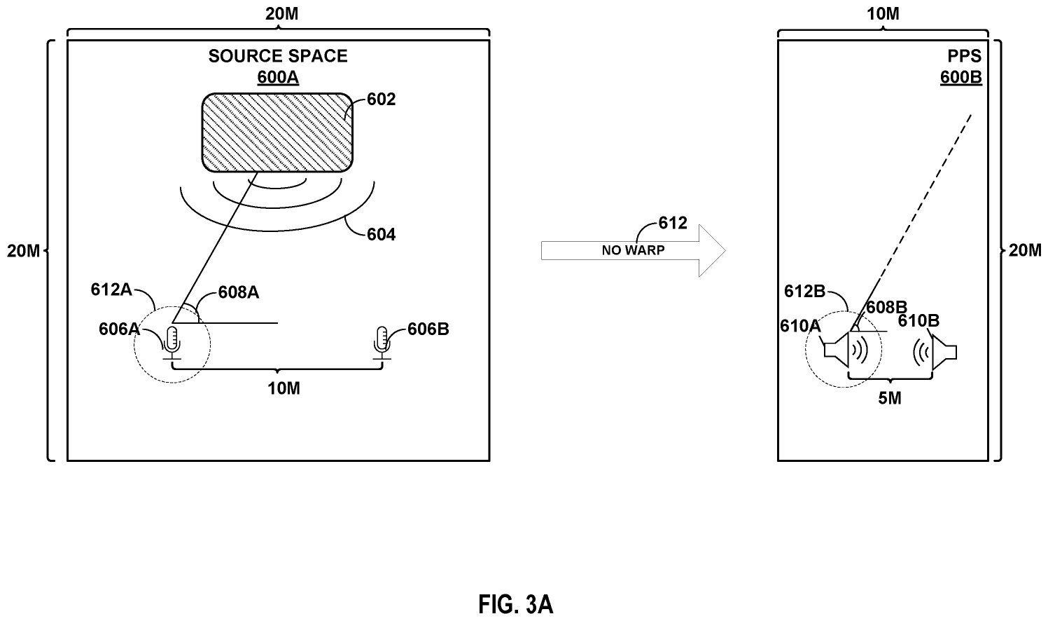

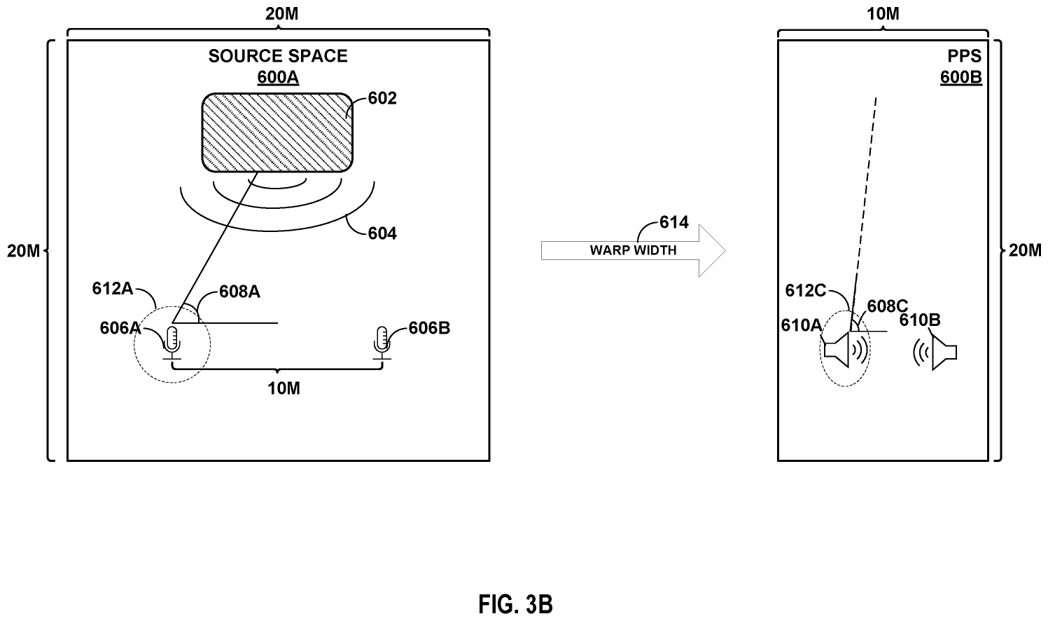

FIGS. 3A and 3B are block diagrams illustrating further example physical spaces in which various aspects of the rescaling techniques are performed in order to facilitate increased immersion while consuming extended reality scenes. Referring first to the example of FIG. 3A, a source space 600A is the same, or substantially similar to, the source space 500A in terms of dimensionality (20 M width by 20 M length), while a PPS 600B is different from the PPS 500B in terms of dimensionality (10 M width by 20 M length of PPS 600B compared to 6 M width by 6 M length of PPS 500B).

The audio playback system 16B may determine an aspect ratio of the source space 600A and an aspect ratio of the PPS 600B. That is, the audio playback system 16A may determine a source aspect ratio of the source space 600A based on the source width (20 M) and the source length (20 M), which results in the source aspect ratio (in this example) for the source space 600A equaling 1:1. The audio playback system 16A may also determine the aspect ratio for the PPS 600B based on the playback width of 10 M and a playback length of 20 M, which results in the playback aspect ratio (in this example) for the PPS 600B equaling 1:2.

The audio playback system 16 may determine a difference between the playback aspect ration (e.g., 1:1) to the source aspect ratio (e.g., 1:2). The audio playback system 16 may compare the difference between the playback aspect ratio and the source aspect ratio to a threshold difference. The audio playback system 16 may, when the difference between the playback aspect ratio and the source aspect ratio exceeds the threshold difference, audio warping with respect to the audio element representing the audio soundfield 604 as captured by, in this example, a microphone 606A (which may represent an example of the microphone 506A, while a microphone 606B may represent an example of the microphone 506B).

More information regarding audio warping can be found in the following references: 1) a publication by Zotter, F. et al. entitled “Warping of the Recording Angle in Ambisonics,” from 1^{st} International Conference in Spatial Audio, Detmold, 2011; 2) a publication by Zotter, F. et al. entitled “Warping of 3D Ambisonic Recordings,” in Ambisonics Symposium, Lexington, 2011; and 3) a publication by Kronlachner, Matthias, et al. entitled “Spatial Transformations for the Enhancement of Ambisonic Recordings,” in Proceedings of the 2^{nd} International Conference on Spatial Audio, Erlangen, 2014. Audio warping may involve warping of the recording perspective and directional loudness modification of HOA.

That is, audio warping may involve application of the following mathematical equations in which a substitution is used to simplify subsequent warping curves in order to express the manipulation of the angle υ as follows:
μ=sin(υ), original,
\tilde{υ}=sin(\tilde{υ}), warped,
   Warping towards and away from equator may occur using the following equation, which is another useful warping curve preserving the elevation of the equator. The following equation is neutral for β=0, pushes surround sound content away form the equator to the poles for β>0, or pulls it towards the equator for β<0:

$$\tilde{μ} = \{ \begin{matrix}\frac{( \vert β \vert - 1 ) + \sqrt{{( ( \vert β \vert - 1 ) )}^{2} + 4 \vert β \vert {μ}^{2}}}{2 \vert β \vert μ} , for β > 0 , \\ \frac{( 1 - \vert β \vert ) μ}{1 - \vert β \vert {μ}^{2}} , for β < 0 .\end{matrix}$$

The rescale factor discussed in this disclosure may be defined as β=−(rescale factor).

In instances where the rescale occurs in the height dimension, the audio playback system 16A may apply the following warping towards a pole as set forth in the following equation.

$$\tilde{μ} = \frac{μ + α}{1 + α μ}$$

The operator is neutral for α=0, and depending on the sign of α, it elevates or lowers the equator υ=0 of the original. In other words, if the height of the XR space is smaller, the audio playback system 16A may push sounds towards the sound pole and thus set α=−(height rescale factor).

The example of FIG. 3A shows how the audio playback system 16A may distort, through rescaling between different source and playback aspect ratios, reproduction of the soundfield 604 by loudspeakers 610A and 610B (which may represent examples of the loudspeakers 510 of the audio playback system 16A). As shown in the example of FIG. 3A, the angle of incidence 608A of the audio element representing the audio soundfield 604 as captured by the microphone 608A is centered on a stage 602 (which is another example of the stage 502 shown in the example of FIG. 2). However, the audio playback system 16A in rescaling the location of the audio element prior to reproduction by the loudspeakers 610 may result in reproduction that results in an angle of incidence 608B that presents the audio element as arriving from the far right.

In this example, the audio playback system 16A may compute a rescale factor 612 that includes no warping (“NO WARP”). A capture soundfield 612A is denoted by a dashed circle to show that the soundfield 604 was captured without warping. A reproduction soundfield 612B is shown as a dashed circle to denote that reproduction of the soundfield 604 (from the captured audio element) is also not warped.

Referring next to the example of FIG. 3B, the audio playback system 16A may perform, when the difference between the playback aspect ratio and the source aspect ratio exceeds the threshold difference, audio warping with respect to the audio element representing the audio soundfield 604 as captured by, in this example, a microphone 606A. In this example, the audio playback system 16A determines that the width is resulting in the difference between the source and playback aspect ratios. The audio playback system 16A may then perform, based on the difference in widths between the source space 600A and the PPS 600B, audio warping to preserve an angle of incidence 608A for the audio element representing the audio soundfield 604 as captured by the microphone 606A.

In performing the audio warping, the audio playback system 16A may (when the audio element is defined using higher order ambisonics—HOA—that conforms to a scene-based audio format having coefficients associated with a zero order and additional higher orders, such as first order, second order, etc. spherical basis functions) remove the coefficients associated with the zero-order spherical basis function (or, in other words, a zero-order basis function). The audio playback system 16A may next perform audio warping with respect to the modified higher order ambisonic coefficients (e.g., obtained after removing the coefficients associated with the zero-order basis function) to preserve the angle of incidence 608A for the audio element and obtain warped higher order ambisonic coefficients. The audio playback system 16A may then render, based on the modified location (due to, in this example, rescaling as discussed herein), the warped higher order ambisonic coefficients and the coefficients corresponding to the zero order ambisonic coefficients to obtain the one or more speaker feeds 25.

In the example of FIG. 3B, the audio playback system 16A may determine or otherwise obtain a rescale factor 614 that includes warping via the difference in width (but not lengths) between the source space 600A and the PPS 600B. The audio warping results in a reproduction soundfield 612C that is distorted to preserve the angle of incidence 608A in which the audio element is perceived as arriving from the center of the stage 602. The angle of incidence 608C is warped to preserve the angle of incidence 608A within the context of PPS 600B and given that reproduction of the audio soundfield 604 has been rescaled. In this respect, the audio playback system 16A may perform, based on the playback dimension and the source dimension, audio warping with respect to the audio element to preserve an angle of incidence 608A for the audio element (during reproducing in the context of the PPS 600B).

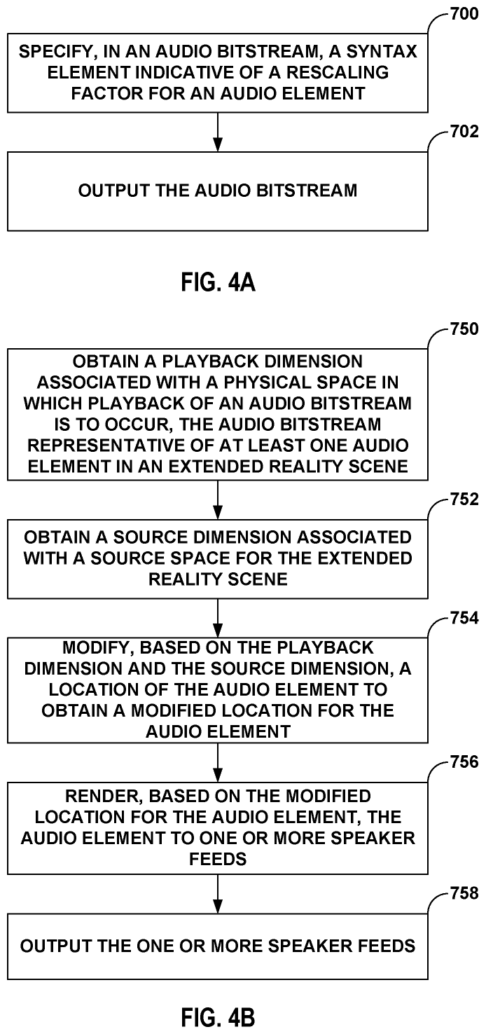

FIGS. 4A and 4B are flowcharts illustrating exemplary operation of an extended reality system shown in the example of FIG. 1 in performing various aspects of the rescaling techniques described in this disclosure. Referring first the example of FIG. 4A, the soundfield representation generator 302 may specify, in the audio bitstream 21, a syntax element indicative of a rescaling factor for the audio element (700). The rescaling factor may indicating how a location of the audio element is to be rescaled relative to other audio elements. The soundfield representation generator 302 may also specify a syntax element indicating that auto rescale is to be performed for a duration in which the audio element is present for playback. The soundfield representation generator 302 may then output the audio bitstream 21 (702).

Referring next to the example of FIG. 4B, the audio playback system 16A may receive the audio bitstream 21. The audio playback system 16A may obtain a playback dimension (one or more playback dimensions) associated with a physical space in which playback of the audio bitstream 21 is to occur (750). That is, the audio playback device 16A may interface with a user operating the audio playback device 16A to identify the playback dimensions (e.g., through an interactive user interface in which the user moves around the room to identify the playback dimensions) (and/or via a remote camera mounted to capture playback of the XR scene, via a head-mounted camera to capture playback/interactions of/with the XR scene, etc.).

In some instances, the audio playback system 16A may also extract, from the audio bitstream 21, syntax elements indicative of one or more source dimensions associated with a source space for the XR scene the syntax elements may be specified in a side channel of metadata or other extensions to the audio bitstream 21. Regardless, the audio playback system 16A may parse the source dimensions (e.g., as syntax elements) from the audio bitstream 21 or otherwise obtain the source dimensions associated with the source space for the XR scene (752).

The audio playback system 16A may then modify, based on the playback dimension an the source dimension, a location associated with the audio element to obtain a modified location for the audio element (754). In this respect, the audio decoding device 24 may parse the audio element from the audio bitstream 21, which is represented in the example of FIG. 1 as the ambisonic audio data 15 (which may represent one or more audio elements). While described with respect to the ambisonic audio data 15, various other audio data formats may be rescaled according to various aspects of the techniques, where other audio data formats may include object-based formats, channel-based formats, and the like.

In terms of performing audio rescaling, the audio playback system 16A may determine whether a difference between the source dimension and the playback dimension exceeds a threshold difference (e.g., more than 1%, 5%, 10%, 20%, etc. difference between the source dimension and the playback dimension). If the difference between the source dimension and the playback dimension exceeds the different threshold (defined, for example, as 1%, 5%, 10%, 20%, etc.), the audio playback system 16A may then determine the rescaling factor. The audio playback system 16A may determine the rescaling factor as a function of the playback dimension divided by the source dimension.

In instances of linear rescaling, the audio playback system 16A may determine the rescaling factor as the playback dimension divided by the source dimension. For example, assuming the source dimension is 20 M and the playback dimension is 6 M, the audio playback system 16A may compute the rescaling factor as 6 M/20 M, which equals 0.3 or 30% as the rescaling factor. The audio playback system 16A may apply the audio factor (e.g., 30%) when invoking the scene manager 23.

The audio playback system 16A may invoke the scene manager 23, passing the rescaling factor to the scene manager 23. The scene manager 23 may apply the rescaling factor when processing the audio elements extracted from the audio bitstream 21. The scene manager 23 may modify metadata defining a location of the audio element in the XR scene, rescaling metadata defining the location of the audio object to obtain the modified location of the audio object. The scene manager 23 may pass the modified location to the audio renderer 22, which may render, based on the modified location for the audio element, the audio element to the speaker feeds 25 (756). The audio renderers 22 may then output the speaker feeds 25 for playback by the audio playback system 16A (which may include one or more loudspeakers configured to reproduce, based on the speaker feeds 25, a soundfield (758).

The audio decoding device 24 may parse the above noted syntax elements indicating a rescale factor and an audio rescale is to be performed. When the rescale factor is specified in the manner noted above, the audio playback system 16A may obtain the rescale factor directly from the audio bitstream 21 (meaning, in this instance, without computing the rescale factor as a function of the playback dimension being divided by the source dimension). The audio playback system 16A may then apply the rescale factor in the manner noted above to obtain the modified location of the audio element.

When processing the syntax element indicative of auto rescale, the audio playback system 16A may refrain from rescaling audio elements associated with the auto rescale syntax element indicating that auto rescale is not to be performed. Otherwise, the audio playback system 16A may process audio elements associated with the audio rescale syntax element indicating that auto rescale is to be performed using various aspects of the techniques described in this disclosure for performing rescale. The auto rescale syntax element may configure the audio playback system 16A to continually apply the rescale factor to the associated audio element while the associated audio element is present in the XR scene.

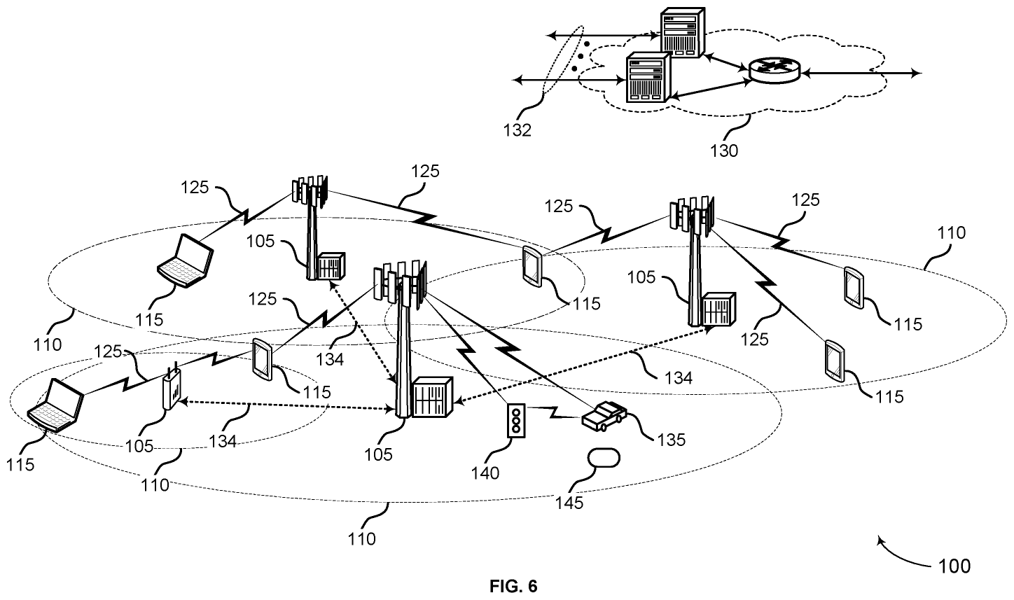

FIG. 6 illustrates an example of a wireless communications system 100 that supports audio streaming in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In examples of this disclosure, a UE 115 may be any of the audio sources described in this disclosure, including a VR headset, an XR headset, an AR headset, a vehicle, a smartphone, a microphone, an array of microphones, or any other device including a microphone or is able to transmit a captured and/or synthesized audio stream. In some examples, an synthesized audio stream may be an audio stream that that was stored in memory or was previously created or synthesized. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that exchange and/or use audio metadata indicating privacy restrictions and/or password-based privacy data to toggle, mask, and/or null various audio streams and/or audio sources as will be described in more detail below.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, the VR device (or the streaming device) may communicate, using a network interface coupled to a memory of the VR/streaming device, exchange messages to an external device, where the exchange messages are associated with the multiple available representations of the soundfield. In some examples, the VR device may receive, using an antenna coupled to the network interface, wireless signals including data packets, audio packets, visual packets, or transport protocol data associated with the multiple available representations of the soundfield. In some examples, one or more microphone arrays may capture the soundfield.

In some examples, the multiple available representations of the soundfield stored to the memory device may include a plurality of object-based representations of the soundfield, higher order ambisonic representations of the soundfield, mixed order ambisonic representations of the soundfield, a combination of object-based representations of the soundfield with higher order ambisonic representations of the soundfield, a combination of object-based representations of the soundfield with mixed order ambisonic representations of the soundfield, or a combination of mixed order representations of the soundfield with higher order ambisonic representations of the soundfield.

In some examples, one or more of the soundfield representations of the multiple available representations of the soundfield may include at least one high-resolution region and at least one lower-resolution region, and wherein the selected presentation based on the steering angle provides a greater spatial precision with respect to the at least one high-resolution region and a lesser spatial precision with respect to the lower-resolution region.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, including fixed function processing circuitry and/or programmable processing circuitry, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

In this respect, the various aspects of the techniques may enable the following examples.

Example 1. A device configured to process an audio bitstream, the device comprising: a memory configured to store the audio bitstream representative of an audio element in an extended reality scene; and processing circuitry coupled of the memory and configured to: obtain a playback dimension associated with a physical space in which playback of the audio bitstream is to occur; obtain a source dimension associated with a source space for the extended reality scene; modify, based on the playback dimension and the source dimension, a location of the audio element to obtain a modified location for the audio element; render, based on the modified location for the audio element, the audio element to one or more speaker feeds; and output the one or more speaker feeds.

Example 2. The device of example 1, wherein the processing circuitry is, when configured to modify the location of the audio element, configured to: determine, based on the playback dimension and the source dimension, a rescale factor; and apply the rescale factor to the location of the audio element to obtain the modified location for the audio element.

Example 3. The device of example 2, wherein the processing circuitry is further configured to obtain, from the audio bitstream, a syntax element indicating that auto rescale is to be performed for the audio element, and wherein the processing circuitry is, when configured to apply the rescale factor, automatically apply, for a duration in which the audio element is present for playback, the rescale factor to the location of the audio element to obtain the modified location for the audio element.

Example 4. The device of any combination of examples 2 and 3, wherein the processing circuitry is, when configured to determine the rescale factor, configured to determine the rescale factor as the playback dimension divided by the source dimension.

Example 5. The device of any combination of examples 1-4, wherein the playback dimension includes one or more of a width of the physical space, a length of the physical space, and a height of the physical space.

Example 6. The device of any combination of examples 1-5, wherein the source dimension includes one or more of a width of the source space, a length of the source space, and a height of the source space.

Example 7. The device of any combination of examples 1-6, wherein the processing circuitry is, when configured to render the audio element, configured to perform, based on the playback dimension and the source dimension, audio warping with respect to the audio element to preserve an angle of incidence for the audio element.

Example 8. The device of any combination of examples 1-7, wherein the playback dimension includes a width of the physical space and a length of the physical space, wherein the playback dimension includes a width of the source space and a length of the source space, and wherein the processing circuitry is, when configured to render the audio element, configured to: determine, based on the width of the physical space and the length of the physical space, a playback aspect ratio; determine, based on the width of the source space and the length of the source space scene, a source aspect ratio; and perform, when a difference between the playback aspect ratio and the source aspect ratio exceeds a threshold difference, audio warping with respect to the audio element to preserve an angle of incidence for the audio element.

Example 9. The device of any combination of examples 7 and 8, wherein the audio element is defined using higher order ambisonic coefficients that conform to a scene-based audio format, wherein the higher order ambisonic coefficients include coefficients associated with a zero order basis function, and wherein the processing circuitry is, when configured to perform the audio warping, configured to: remove the coefficients associated with the zero order basis function to obtain modified higher order ambisonic coefficients; perform, based on the playback dimension and the source dimension, audio warping with respect to the modified higher order ambisonic coefficients to preserve an angle of incidence for the audio element and obtain warped higher order ambisonic coefficients; and render, based on the modified location, the warped higher order ambisonic coefficients and the coefficients corresponding to the zero order spherical basis function, to obtain the one or more speaker feeds.

Example 10. The device of any combination of examples 1-9, wherein the audio element comprises a first audio element, wherein the processing circuitry is further configured to obtain, from the audio bitstream, a syntax element that specifies a rescale factor relative to a second audio element, and wherein the processing circuitry is, when configured to modify the location of the audio element, configured to apply the rescale factor to rescale a location of the first audio element relative to a location of the second audio element to obtain the modified location for the first audio element.

Example 11. The device of any combination of examples 1-10, further comprising one or more speakers configured to reproduce, based on the one or more speaker feeds, a soundfield.

Example 12. A method of processing an audio element, the method comprising: obtaining a playback dimension associated with a physical space in which playback of an audio bitstream is to occur, the audio bitstream representative of the audio element in an extended reality scene; obtaining a source dimension associated with a source space for the extended reality scene; modifying, based on the playback dimension and the source dimension, a location of the audio element to obtain a modified location for the audio element; rendering, based on the modified location for the audio element, the audio element to one or more speaker feeds; and outputting the one or more speaker feeds.

Example 13. The method of example 12, wherein modifying the location of the audio element comprising: determining, based on the playback dimension and the source dimension, a rescale factor; and applying the rescale factor to the location of the audio element to obtain the modified location for the audio element.

Example 14. The method of example 13, further comprising obtaining, from the audio bitstream, a syntax element indicating that auto rescale is to be performed for the audio element, and wherein applying the rescale factor comprises automatically applying, for a duration in which the audio element is present for playback, the rescale factor to the location of the audio element to obtain the modified location for the audio element.

Example 15. The method of any combination of examples 13 and 14, wherein determining the rescale factor comprises determining the rescale factor as the playback dimension divided by the source dimension.

Example 16. The method of any combination of examples 12-15, wherein the playback dimension includes one or more of a width of the physical space, a length of the physical space, and a height of the physical space.

Example 17. The method of any combination of examples 12-16, wherein the source dimension includes one or more of a width of the source space, a length of the source space, and a height of the source space.

Example 18. The method of any combination of examples 12-16, wherein rendering the audio element comprises performing, based on the playback dimension and the source dimension, audio warping with respect to the audio element to preserve an angle of incidence for the audio element.

Examples 19. The method of any combination of examples 12-18, wherein the playback dimension includes a width of the physical space and a length of the physical space, wherein the playback dimension includes a width of the source space and a length of the source space, wherein rendering the audio element comprises: determining, based on the width of the physical space and the length of the physical space, a playback aspect ratio; determining, based on the width of the source space and the length of the source space scene, a source aspect ratio; and performing, when a difference between the playback aspect ratio and the source aspect ratio exceeds a threshold difference, audio warping with respect to the audio element to preserve an angle of incidence for the audio element.

Example 20. The method of any combination of examples 18 and 19, wherein the audio element is defined using higher order ambisonic coefficients that conform to a scene-based audio format, wherein the higher order ambisonic coefficients include coefficients associated with a zero order basis function, wherein performing the audio warping comprises: removing the coefficients associated with the zero order basis function to obtain modified higher order ambisonic coefficients; performing, based on the playback dimension and the source dimension, audio warping with respect to the modified higher order ambisonic coefficients to preserve an angle of incidence for the audio element and obtain warped higher order ambisonic coefficients; and rendering, based on the modified location, the warped higher order ambisonic coefficients and the coefficients corresponding to the zero order spherical basis function, to obtain the one or more speaker feeds.

Example 21. The method of any combination of examples 12-20, wherein the audio element comprises a first audio element, wherein the method further comprises obtaining, from the audio bitstream, a syntax element that specifies a rescale factor relative to a second audio element, and wherein modifying the location of the audio element comprises applying the rescale factor to rescale a location of the first audio element relative to a location of the second audio element to obtain the modified location for the first audio element.

Example 22. The method of any combination of examples 12-21, further comprising reproducing, by one or more speakers, and based on the one or more speaker feeds, a soundfield.

Example 23. A device configured to encode an audio bitstream, the device comprising: a memory configured to store an audio element, and processing circuitry coupled to the memory, and configured to: specify, in the audio bitstream, a syntax element indicative of a rescaling factor for the audio element, the rescaling factor indicating how a location of the audio element is to be rescaled relative to other audio elements; and output the audio bitstream.

Example 24. The device of example 23, wherein the audio element is defined using higher order ambisonic coefficients that conform to a scene-based audio format, and wherein the higher order ambisonic coefficients include coefficients associated with a zero order basis function.

Example 25. The device of example 23, wherein the processing circuitry is further configured to specify, in the audio bitstream, a syntax element indicating that auto rescale is to be performed for the audio element.

Example 26. The device of example 25, wherein the syntax element indicating that auto rescale is to be performed for the audio element indicates that auto rescale is to be performed, for a duration in which the audio element is present for playback, the rescale factor to the location of the audio element to obtain the modified location for the audio element.

Example 27. A method for encoding an audio bitstream, the method comprising: specifying, in the audio bitstream, a syntax element indicative of a rescaling factor for an audio element, the rescaling factor indicating how a location of the audio element is to be rescaled relative to other audio elements; and output the audio bitstream.

Example 28. The method of example 27, wherein the audio element is defined using higher order ambisonic coefficients that conform to a scene-based audio format, and wherein the higher order ambisonic coefficients include coefficients associated with a zero order basis function.

Example 29. The method of example 27, further comprising specifying, in the audio bitstream, a syntax element indicating that auto rescale is to be performed for the audio element.

Example 30. The method of example 27, wherein the syntax element indicating that auto rescale is to be performed for the audio element indicates that auto rescale is to be performed, for a duration in which the audio element is present for playback, the rescale factor to the location of the audio element to obtain the modified location for the audio element.

Various examples have been described. These and other examples are within the scope of the following claims.

What is claimed is:

1. A device configured to process an audio bitstream, the device comprising:
a memory configured to store the audio bitstream representative of an audio element in an extended reality scene; and
processing circuitry coupled of the memory and configured to:
obtain a playback dimension associated with a physical space in which playback of the audio bitstream is to occur;
obtain a source dimension associated with a source space for the extended reality scene;
modify, based on the playback dimension and the source dimension, a location of the audio element to obtain a modified location for the audio element;
render, based on the modified location for the audio element, the audio element to one or more speaker feeds; and
output the one or more speaker feeds.

2. The device of claim 1, wherein the processing circuitry is, when configured to modify the location of the audio element, configured to:
determine, based on the playback dimension and the source dimension, a rescale factor; and
apply the rescale factor to the location of the audio element to obtain the modified location for the audio element.

3. The device of claim 2,
wherein the processing circuitry is further configured to obtain, from the audio bitstream, a syntax element indicating that auto rescale is to be performed for the audio element, and
wherein the processing circuitry is, when configured to apply the rescale factor, automatically apply, for a duration in which the audio element is present for playback, the rescale factor to the location of the audio element to obtain the modified location for the audio element.

4. The device of claim 2, wherein the processing circuitry is, when configured to determine the rescale factor, configured to determine the rescale factor as the playback dimension divided by the source dimension.

5. The device of claim 1, wherein the playback dimension includes one or more of a width of the physical space, a length of the physical space, and a height of the physical space.

6. The device of claim 1, wherein the source dimension includes one or more of a width of the source space, a length of the source space, and a height of the source space.

7. The device of claim 1, wherein the processing circuitry is, when configured to render the audio element, configured to perform, based on the playback dimension and the source dimension, audio warping with respect to the audio element to preserve an angle of incidence for the audio element.

8. The device of claim 1,
wherein the playback dimension includes a width of the physical space and a length of the physical space,
wherein the playback dimension includes a width of the source space and a length of the source space, and
wherein the processing circuitry is, when configured to render the audio element, configured to:
determine, based on the width of the physical space and the length of the physical space, a playback aspect ratio;
determine, based on the width of the source space and the length of the source space scene, a source aspect ratio; and
perform, when a difference between the playback aspect ratio and the source aspect ratio exceeds a threshold difference, audio warping with respect to the audio element to preserve an angle of incidence for the audio element.

9. The device of claim 7,
wherein the audio element is defined using higher order ambisonic coefficients that conform to a scene-based audio format,
wherein the higher order ambisonic coefficients include coefficients associated with a zero order basis function, and
wherein the processing circuitry is, when configured to perform the audio warping, configured to:
remove the coefficients associated with the zero order basis function to obtain modified higher order ambisonic coefficients;
perform, based on the playback dimension and the source dimension, audio warping with respect to the modified higher order ambisonic coefficients to preserve an angle of incidence for the audio element and obtain warped higher order ambisonic coefficients; and
render, based on the modified location, the warped higher order ambisonic coefficients and the coefficients corresponding to the zero order spherical basis function, to obtain the one or more speaker feeds.

10. The device of claim 1,
wherein the audio element comprises a first audio element,
wherein the processing circuitry is further configured to obtain, from the audio bitstream, a syntax element that specifies a rescale factor relative to a second audio element, and
wherein the processing circuitry is, when configured to modify the location of the audio element, configured to apply the rescale factor to rescale a location of the first audio element relative to a location of the second audio element to obtain the modified location for the first audio element.

11. The device of claim 1, further comprising one or more speakers configured to reproduce, based on the one or more speaker feeds, a soundfield.

12. A method of processing an audio element, the method comprising:
obtaining a playback dimension associated with a physical space in which playback of an audio bitstream is to occur, the audio bitstream representative of the audio element in an extended reality scene;
obtaining a source dimension associated with a source space for the extended reality scene;
modifying, based on the playback dimension and the source dimension, a location of the audio element to obtain a modified location for the audio element;
rendering, based on the modified location for the audio element, the audio element to one or more speaker feeds; and
outputting the one or more speaker feeds.

13. The method of claim 12, wherein modifying the location of the audio element comprising:
determining, based on the playback dimension and the source dimension, a rescale factor; and
applying the rescale factor to the location of the audio element to obtain the modified location for the audio element.

14. The method of claim 13, further comprising obtaining, from the audio bitstream, a syntax element indicating that auto rescale is to be performed for the audio element, and
wherein applying the rescale factor comprises automatically applying, for a duration in which the audio element is present for playback, the rescale factor to the location of the audio element to obtain the modified location for the audio element.

15. The method of claim 13, wherein determining the rescale factor comprises determining the rescale factor as the playback dimension divided by the source dimension.

16. The method of claim 12, wherein the playback dimension includes one or more of a width of the physical space, a length of the physical space, and a height of the physical space.

17. The method of claim 12, wherein the source dimension includes one or more of a width of the source space, a length of the source space, and a height of the source space.

18. The method of claim 12, wherein rendering the audio element comprises performing, based on the playback dimension and the source dimension, audio warping with respect to the audio element to preserve an angle of incidence for the audio element.

19. The method of claim 12,
wherein the playback dimension includes a width of the physical space and a length of the physical space,
wherein the playback dimension includes a width of the source space and a length of the source space, and
wherein rendering the audio element comprises:
determining, based on the width of the physical space and the length of the physical space, a playback aspect ratio;
determining, based on the width of the source space and the length of the source space scene, a source aspect ratio; and
performing, when a difference between the playback aspect ratio and the source aspect ratio exceeds a threshold difference, audio warping with respect to the audio element to preserve an angle of incidence for the audio element.

20. The method of claim 18,
wherein the audio element is defined using higher order ambisonic coefficients that conform to a scene-based audio format,
wherein the higher order ambisonic coefficients include coefficients associated with a zero order basis function,
wherein performing the audio warping comprises:
removing the coefficients associated with the zero order basis function to obtain modified higher order ambisonic coefficients;
performing, based on the playback dimension and the source dimension, audio warping with respect to the modified higher order ambisonic coefficients to preserve an angle of incidence for the audio element and obtain warped higher order ambisonic coefficients; and
rendering, based on the modified location, the warped higher order ambisonic coefficients and the coefficients corresponding to the zero order spherical basis function, to obtain the one or more speaker feeds.

21. The method of claim 12,
wherein the audio element comprises a first audio element,
wherein the method further comprises obtaining, from the audio bitstream, a syntax element that specifies a rescale factor relative to a second audio element, and
wherein modifying the location of the audio element comprises applying the rescale factor to rescale a location of the first audio element relative to a location of the second audio element to obtain the modified location for the first audio element.

22. The method of claim 12, further comprising reproducing, by one or more speakers, and based on the one or more speaker feeds, a soundfield.

23. A device configured to encode an audio bitstream, the device comprising:
a memory configured to store an audio element, and
processing circuitry coupled to the memory, and configured to:
specify, in the audio bitstream, a syntax element indicative of a rescaling factor for the audio element, the rescaling factor indicating how a location of the audio element is to be rescaled relative to other audio elements; and
output the audio bitstream.

24. The device of claim 23,
wherein the audio element is defined using higher order ambisonic coefficients that conform to a scene-based audio format, and
wherein the higher order ambisonic coefficients include coefficients associated with a zero order basis function.

25. The device of claim 23, wherein the processing circuitry is further configured to specify, in the audio bitstream, a syntax element indicating that auto rescale is to be performed for the audio element.

26. The device of claim 25, wherein the syntax element indicating that auto rescale is to be performed for the audio element indicates that auto rescale is to be performed, for a duration in which the audio element is present for playback, the rescale factor to the location of the audio element to obtain the modified location for the audio element.

27. A method for encoding an audio bitstream, the method comprising:
specifying, in the audio bitstream, a syntax element indicative of a rescaling factor for an audio element, the rescaling factor indicating how a location of the audio element is to be rescaled relative to other audio elements; and
output the audio bitstream.

28. The method of claim 27,
wherein the audio element is defined using higher order ambisonic coefficients that conform to a scene-based audio format, and
wherein the higher order ambisonic coefficients include coefficients associated with a zero order basis function.

29. The method of claim 27, further comprising specifying, in the audio bitstream, a syntax element indicating that auto rescale is to be performed for the audio element.

30. The method of claim 27, wherein the syntax element indicating that auto rescale is to be performed for the audio element indicates that auto rescale is to be performed, for a duration in which the audio element is present for playback, the rescale factor to the location of the audio element to obtain the modified location for the audio element.
